(19) United States
(12) Patent Application Publication
(10) Pub. No.: US 2007/0048139 A1
(43) Pub. Date: Mar. 1, 2007

(54) Cylindrical rotor with internal blades

(76) Inventor: Joao Bosco de Oliveira, Sao Paulo (BR)

Correspondence Address: Alan M. Weisberg, Esq.;CHRISTOPHER & WEISBERG, P.A., Suite 2040, 200 East Las Olas Boulevard, Fort Lauderdale, FL, 33301, US

(21) Appl. No.: 11/210,154

(22) Filed: Aug. 23, 2005

(51) Int. Cl. B64C 11/00

(52) U.S. Cl. 416/182

(57) ABSTRACT

A cylindrical rotor with internal blades, configured by a ring of variable diameter and length according to necessity, as well as the blade quantity, pitch, surface and angle in its interior, being the assembly made of different materials.

### FIELD OF THE INVENTION

The present invention is in the field of rotors, specifically of cylindrical rotors.

### BACKGROUND OF THE INVENTION

The cylindrical rotor of the present invention presents internal blades and is constructed and arranged for axial flows in pumps or turbines. The flows can be liquid or gas flows with or without suspended sediments or particles.

In the present invention there is a load and flow gain related to the current axial flow rotors due to the absence of a cube and a central axis. This absence allows gases and liquids to flow without any obstruction.

Furthermore, in the present invention the accumulation of debris and particles are substantially minimized in its external and in its base. These accumulations are considered one of the main causes of rotor locking in cases of drainage of fluids with suspended sediments and particles.

The cylindrical rotor of the present invention may be made of several different materials such, but not limited to metal, polymer and porcelain.

### SUMMARY OF THE INVENTION

This application seeks to provide a cylindrical rotor with internal blades comprising a ring (4) with an internal and an external surface, including at least two straight blades (5) including an internal and an external edge, located in the internal surface, wherein the at least two straight blades (5) are equidistantly positioned in opposite directions and placed at the same height and angle, and wherein a central portion of the internal edges (6) crosses the ring in a central axial position.

### BRIEF DESCRIPTION OF THE DRAWINGS

FIG. 1 shows perspective views of conventional rotors to centrifuge pumps with axial or mixed flows.

FIG. 2 shows perspective views of conventional rotors to centrifuge pumps with axial or mixed flows.

FIG. 3 shows a frontal, lateral, cross-section and perspective views of a rotor with two straight blades.

FIG. 4 shows a frontal, lateral, cross-section and perspective views of a rotor with three straight blades.

FIG. 5 shows a frontal, lateral, cross-section and perspective views of a rotor with two straight blades with radials smaller than the cylinder diameter.

FIG. 6 shows a frontal, lateral, cross-section and perspective views of a rotor with two helical blades of one coil with radials smaller than the cylinder diameter.

FIG. 7 shows a frontal, lateral, cross-section and perspective views of a rotor with prolonged cylindrical basis with three sets of straight blades.

FIG. 8 shows a perspective view of rotors with two helical blades of one long-coil pitch.

FIG. 9 shows alternate blade configurations allowed by cylindrical basis.

### DETAILED DESCRIPTION OF THE INVENTION

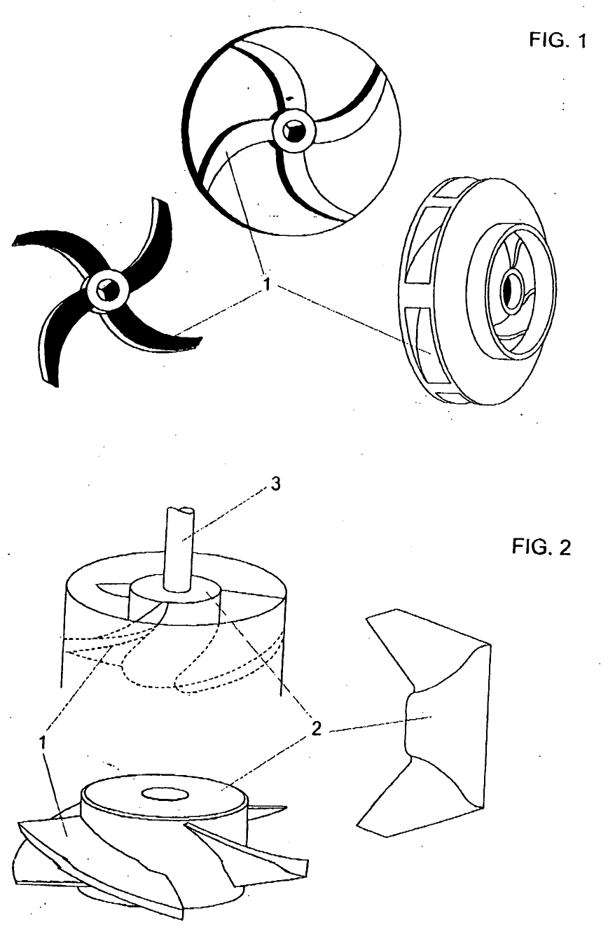

The present invention includes a cylindrical rotor with internal blades. The cylindrical rotor of the present invention comprises multiple blades of different dispositions and shapes. These possibilities overcome the drawbacks of pumps and turbines of the prior art. Blades (1) of conventional centrifuges (FIG. 1) or axial pumps (FIG. 2), although allowing several configurations, are limited by the cube (2) and central axis (3).

In FIG. 3 a rotor it is shown, where a ring (4) including two internal semicircular blades (5), which may be plain, concave or convex blades. The two blades are positioned in opposite directions, both placed at the same height and showing the same angle in relation to a horizontal plane. The blades include an internal and an external edge, and a central portion of the internal edges (6) crosses the ring in a central axial position.

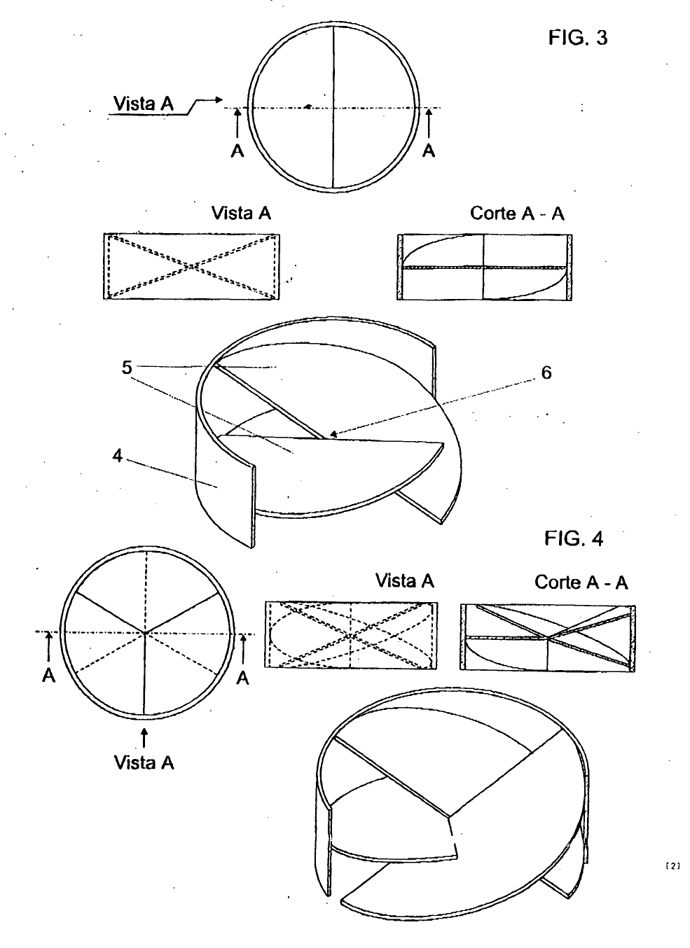

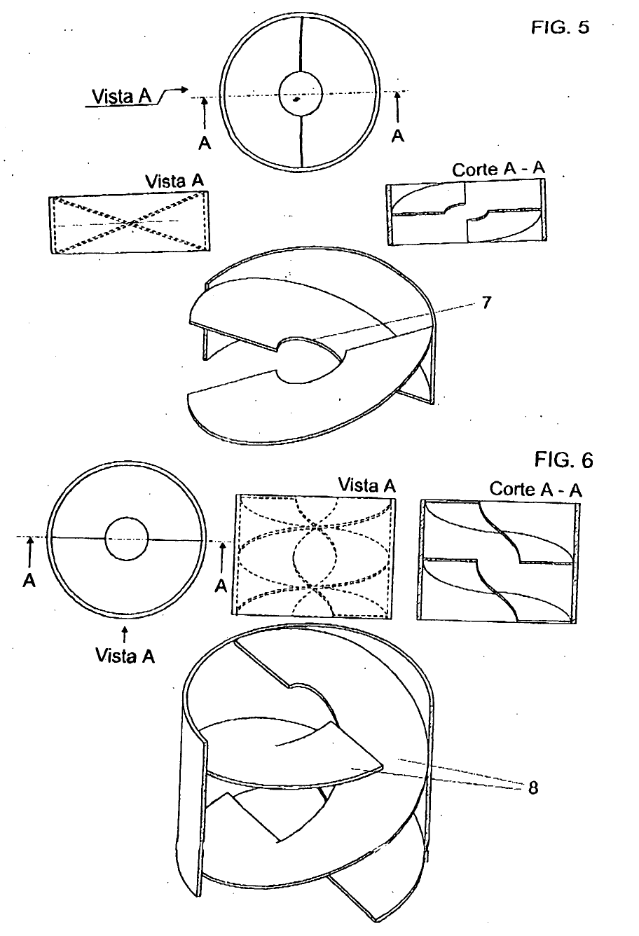

The blades being straight and the inlet and outlet angles being the same enables the efficiency of axial flow to be equivalent in both directions, taking into consideration that the potency and the speed in the opposite directions of rotation are the sense. This is also true for in rotors with three or more blades, as seen in FIG. 4.

The internal edges (radial center) of the blades may also include a depression in a semicircular shape (7), also in a central position, as seen in FIG. 5. In this case the width (radial measure) is smaller than the cylinder radius, being this rotor proper to be used with denser fluids.

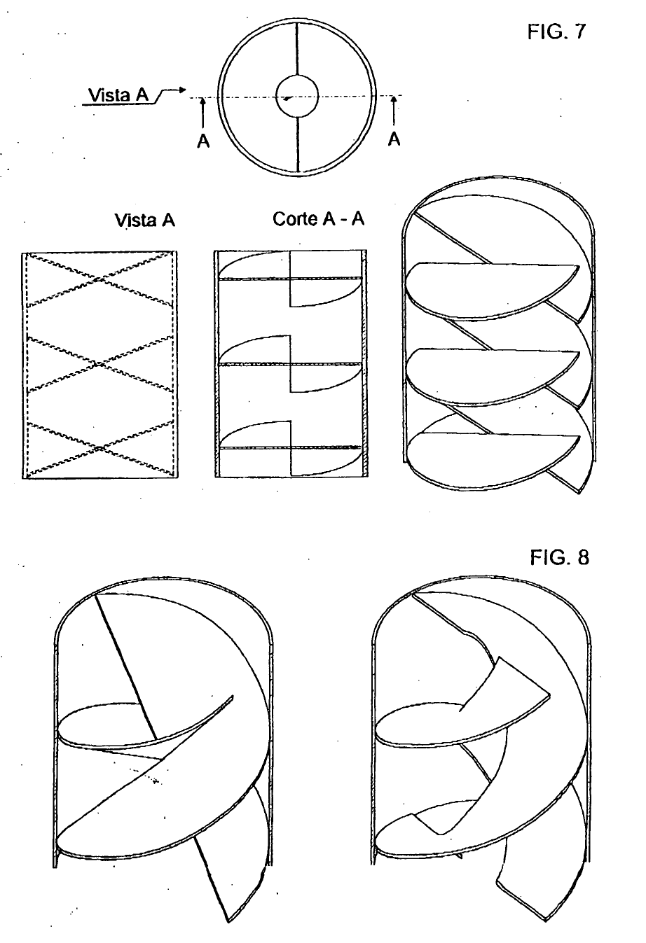

The blades may also be in a coil shape (8), a seen in FIG. 6. Coil shape blades are longer than straight blades, which have theirs maximal size equivalent to half of the generatrix circumference that contains them.

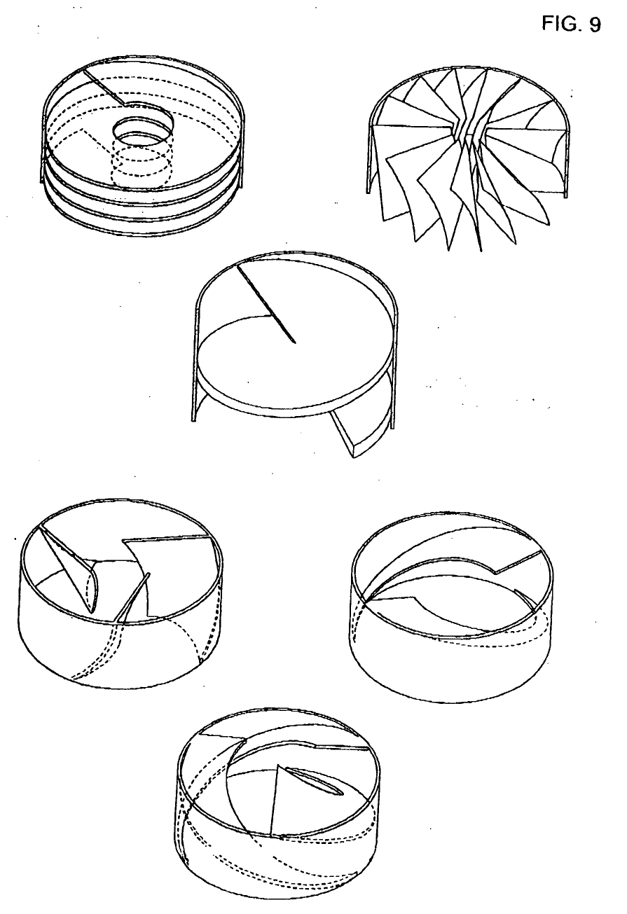

The possibility of prolonging the blades is a significant advantage of the present invention over conventional rotors of axial flows of the prior art, which, in general, have the size of their blades proportional to size of the cube. In the rotor of the present invention this is avoided as the cylindrical and external basis enables, when prolonged, the rotor to comport coils with extremely large pitches, as seen in FIG. 8. The rotor of this invention also enables the rotor to comport two or more blades sets in its interior, as seen in FIG. 7. These characteristics will simulate an axial pump of several stages, leading to a significant gain in flow pressure.

In FIG. 9 it is shown that when the blades are in a coil shape the blades also enable the rotor to present a specific configuration based on speed calculations, hydraulic charge, kinetic height, and etc, increasing or decreasing the pitch, angle, coil number and other relevant factors.

Due to the absence of a cube and as a result an absence of a central axis, the transmission movement is made through belts, pulleys, gears, magnetic or electromagnetic induction, and also made in according to the desired use, capacity, size, potency and other determining factors.

These different transmission types are also applied to rotors used in turbines, where they are used to transform mechanical-rotational work in kinetic energy of a moving fluid.

Blades may also be defined as paddles or propellers.

1. A cylindrical rotor with internal blades comprising a ring with an internal and an external surface, including at least two straight blades including an internal and an external edge, located in the internal surface,
wherein the at least two straight blades are equidistantly positioned in opposite directions and placed at the same height and angle, and
wherein a central portion of the internal edges crosses the ring in a central axial position.

2. The cylindrical rotor according to claim 1, wherein the straight blade is of a shape selected from the group consisting of: plain, concave, convex and helical.

3. The cylindrical rotor according to claim 1, wherein the internal edge of the blade further include a depression in a semicircular shape in a central position when the width of the blade is smaller than the cylinder radius.

4. The cylindrical rotor according to claim 1, wherein the internal edge crosses the center of the ring in a central position when the radius of the blade is equivalent to the radius of the ring.

5. The cylindrical rotor according to claim 1, wherein the blades present identical configurations in angle, pitches and coil number.

6. The cylindrical rotor according to claim 1, wherein the blades present different configurations in angle, pitches and coil number.

7. The cylindrical rotor according to claim 6, wherein the blade different configurations are based on calculations selected from the group consisting of: speed, hydraulic charge, kinetic height and combinations thereof.

8. The cylindrical rotor according to claim 1, wherein the blades are made of a material selected from the group consisting of: metal, polymer and porcelain.
